(19) United States
(12) Patent Application Publication
(10) Pub. No.: US 2007/0065718 A1
(43) Pub. Date: Mar. 22, 2007

(54) Small battery pack having frame retardant adhesive member

(76) Inventor: Ki eob Moon, Seoul (KR)

Correspondence Address: CANTOR COLBURN, LLP, 55 GRIFFIN ROAD SOUTH, BLOOMFIELD, CT, 06002, US

(21) Appl. No.: 11/389,575

(22) Filed: Mar. 24, 2006

(30) Foreign Application Priority Data
Mar. 25, 2005 (KR) 10-2005-0024807

(51) Int. Cl. H01M 2/08; H01M 2/02

(52) U.S. Cl. 429/185; 429/176

(57) ABSTRACT

Provided is a small battery pack having flame retardancy-imparted adhesive members which are external to a battery cell, such as a double-sided adhesive tape used for adhesion between the battery cell and a battery pack case in which the battery cell is mounted, an adhesive used for attachment of a packaging member to the battery cell or battery pack case, and the like. According to the present invention, it is possible to manufacture the battery pack having improved flame retardancy without adverse effects on functional elements of the battery and a need for an extra space and further, without modification of a manufacturing process of the battery pack or addition of new processes.

### FIELD OF THE INVENTION

The present invention relates to a small battery pack having a flame retardant adhesive member. More particularly, the present invention relates to a small battery pack which is capable of preventing or inhibiting ignition of the battery pack by imparting flame retardancy to adhesive members which are external to a battery cell, such as a double-sided adhesive tape used for adhesion between the battery cell and a battery pack case, an adhesive used for attachment of a packaging member to the battery cell or battery pack case, and the like.

### BACKGROUND OF THE INVENTION

Technological development and increased demand for mobile equipment have led to a rapid increase in the demand for secondary batteries as an energy source. Among these secondary batteries, a great deal of research and study has been focused on lithium secondary batteries and thus some of such lithium secondary batteries are commercially available and widely used.

One of the most significant problems, suffered by such lithium secondary batteries, is low safety of the battery. Lithium secondary batteries are susceptible to the high-risk of ignition under various circumstances such as overcharge, heating from external sources, physical deformation and the like. A variety of methods have been proposed for prevention of overcharge as a cause for such a risk of ignition and for prevention of internal short circuiting resulting from physical deformation. However, in spite of such various preventive measures, there is still needed means that can prevent ignition, or can at least inhibit a further progress of ignition when ignition is initiated.

On the other hand, for the purpose of preventing and inhibiting ignition, techniques involving addition of a flame retardant to a portion of a material of interest are widely used in diverse fields. For example, the flame retardant, added to plastic complexes, exerts ignition suppression effects in a manner that, when fire takes place, the flame retardant evolves fire extinguishing gas, or melts to form an oxygen-blocking film on the surface of the complexes. Therefore, it has been demonstrated that use of the flame retardant is highly effective in terms of ignition prevention and suppression.

Further, numerous methods for ignition prevention and suppression via use of such flame retardants have been suggested in a field of battery. For example, a prior art discloses a method of adding phosphoric acid esters to an electrolyte, and Japanese Patent Laid-open Publication No. 1999-154535 discloses a method of incorporating ammonium phosphate into an electrode such as an anode or cathode. In fact, these methods may offer superior ignition suppression capability, but suffer from an inevitable problem associated with deterioration of battery performance caused from direct application of such flame retardants to main functional elements of the secondary battery.

Taking into account such problems, there may be considered a method of adding flame retardants to elements or spaces which do not affect the operation of batteries. However, for secondary batteries having a structure in which a battery cell having a chargeable/dischargeable electrode assembly contained therein is mounted in the given pack case, a variety of elements including the battery cell are densely arranged in a limited space of the pack case, which thereby leads to great limitation in addition of extra components. That is, as described above, an extra space for addition of other components to the battery pack without addition to main functional elements of the battery is highly limited.

Structural alteration or modification of the battery pack to secure such an extra space leads to a further increased size in the battery pack, which undesirably runs counter to the continuing current development trend toward miniaturization, slimness and weight reduction of the battery pack. Further, in the inner space of the battery cell, in which an electrode assembly composed of cathode/separator/anode is contained in the battery case in the state impregnated in the electrolyte, there is substantially no extra space for addition of the flame retardant without affecting functional elements of the battery.

Meanwhile, among elements constituting the battery pack, there are some structural components made of materials that are combustible upon ignition of the battery pack. Such combustible materials generally consist of chemical substances such as plastic resins, and burn with production of toxic gas and combustible gas, which further accelerates ignition of the battery pack.

Consequently, there is an urgent need for the development of a technology that can impart flame retardancy to the battery pack, without direct addition of the flame retardant to the electrolyte, cathode or anode active material and the like and without a need for an extra space for addition of the flame retardant.

Therefore, the present invention has been made to solve the above problems, and other technical problems that have been desired to be solved from the past.

As a result of a variety of extensive and intensive studies and experiments to solve the problems as described above, the inventors of the present invention have discovered that when adhesive members used to fabricate a small battery pack are generally flammable and further, flame retardants are added to such adhesive members or the adhesive members are made of flame retardant materials, it is possible to manufacture the battery pack having improved flame retardancy without adverse effects on functional elements of the battery and a need for an extra space and further, without modification of a manufacturing process of the battery pack or addition of new processes. The present invention has been completed based on these findings.

### SUMMARY OF THE INVENTION

In accordance with an aspect of the present invention, the above and other objects can be accomplished by the provision of a battery pack having a flame retardancy-imparted adhesive member external to a battery cell.

As discussed above, in structural components of the battery cell, i.e. a cathode, an anode, a separator and an electrolyte, and an inner space of a battery case in which these battery cell components are contained in the sealed state, there is no separate space to impart flame retardancy without direct effects on the operation of the battery.

Whereas, at the outside of the battery cell, there are some materials that can be applied to impart flame retardancy while having no adverse effects on the operation of the battery. For example, in a pouch-type battery cell, a pack case, which is mounted on the outer surface of the battery cell for protection thereof, is composed of a rectangular pack case body in which the battery cell can be housed, a cap assembly which is loaded on the top of the battery cell, under the condition of being housed in the pack case body, and a pack case cover for enclosing an open upper part of the pack case body. Components of the cap assembly are directly responsible for the operation of the battery, while the pack case body and cover serve to protect the battery cell and cap assembly from the external environment. Therefore, a method of adding flame retardants to the pack case body and cover may be taken into account. For that reason, there may be considered a method of fabricating the pack case body and/or cover using noncombustible materials such as stainless steels, or a method of adding flame retardants to plastic materials. However, the latter method of adding flame retardants to the combustible material may result in deterioration of mechanical properties such as strength, thereby compromising the specific functions intrinsic to the pack case.

However, the present invention achieves desired objects by imparting flame retardancy to a double-sided adhesive tape which is used for stable fixation of the pouch-type battery cell in the pack case, an adhesive which is used for attachment of a packaging member enclosing the outer surface of the pack case of the pouch-type battery cell or a packaging member enclosing the outer surface of a square-type battery cell, and the like. The double-sided adhesive tape is adhered to both the battery cell and pack case, and thereby serves to maintain the fixed state of the battery cell without shaking thereof by external impact. Further, the above-mentioned adhesive serves to attach the packaging member to the battery cell or pack case. Since adhesive members including such double-sided adhesive tape and adhesive achieve the above-mentioned objects via their own adhesive forces, deterioration of mechanical properties resulting from addition of flame retardants or use of flame retardant materials does not damage intrinsic functions of the adhesive members.

For example, the double-sided adhesive tape is generally composed of a base film having adequate toughness and adhesive layers applied to both sides of the base film, whereas the packaging member is composed of the base film as mentioned above and an adhesive layer applied to one side of the base film. Generally, the base film is formed of a resin film such as polyester, polyethylene, polypropylene or the like, and the adhesive layer is formed of an acrylic material, a urethane material or the like. In one embodiment of the present invention, flame retardancy can be secured by adding the flame retardant to the base film and/or adhesive layer, or fabricating such a base film and/or adhesive layer using flame retardant materials. When it is added, the content of the flame retardant may be determined within the range capable of conferring flame retardancy while not damaging functions of the base film and adhesive layer. Similarly, when the base film and adhesive layer are made of flame retardant materials, suitable materials may be selected which are capable of imparting flame retardancy without causing serious degradation of functions of the base film and adhesive layer. In one preferred embodiment, it is possible to endow the double-sided adhesive tape with flame retardancy, via addition of the flame retardant to the adhesive layer, or formation of the adhesive layer using flame retardant materials.

As the flame retardants, there may be used halogen-based flame retardants, phosphorus-based flame retardants and inorganic flame retardants. If necessary, these materials may be used alone or in any combination thereof.

The halogen-based flame retardants generally exert flame retardant effects by substantially stabilizing radicals generating in a gaseous phase. Examples of the halogen-based flame retardants may include tribromo phenoxyethane, tetrabromo bisphenol-A (TBBA), octabromo diphenylether (OBDPE), brominated epoxy, brominated polycarbonate oligomer, chlorinated paraffin, chlorinated polyethylene and alicyclic chlorine-based flame retardants.

The phosphorus-based flame retardants generally exert flame retardant effects in a manner that they generate poly-metaphosphoric acid via pyrolysis and the resulting poly-metaphosphoric acid forms a protective layer, or a carbon film, which is formed by dehydration action occurring upon generation of poly-metaphosphoric acid, blocks oxygen. Examples of the phosphorus-based flame retardants may include red phosphorus, phosphates such as ammonium phosphate, phosphine oxides, phosphine oxide diols, phosphites, phosphonates, triaryl phosphates, alkyldiaryl phosphates, trialkyl phosphates and resorcinol bisdiphenyl phosphate (RDP).

Inorganic flame retardants generally exert flame retardant effects in a manner that they undergo thermal decomposition to release noncombustible gases such as water vapor, carbon dioxide (CO₂), sulfur dioxide and hydrogen chloride and induce endothermic reaction, thereby diluting combustible gases to prevent access of oxygen, and the thus-induced endothermic reaction results in cooling of combustible gases and reduced production of pyrolytic products. Examples of the inorganic flame retardants, mention may be made of aluminum hydroxide, magnesium hydroxide, antimony hydroxide, tin hydroxide, tin oxide, molybdenum oxide, zirconium compounds, borates, calcium salts and the like.

Where appropriate, other additives capable of inducing flame retardancy-synergistic effects, upon using in admixture with the above-exemplified flame retardants, may be further included.

As the flame retardancy-conferred double-sided adhesive tape, ST#9553 (Lihwa Corporation, Korea) is commercially available. An example of the flame retardant adhesive tape is known from Korean Patent Registration No. 315130. Therefore, the above-mentioned conventional products and arts in connection with flame-retardant adhesive members are incorporated by reference herein in its entirety.

The battery cell in the battery pack of the present invention is not particularly limited and may be preferably secondary batteries, particularly lithium secondary batteries such as lithium ion secondary batteries and lithium ion polymer secondary batteries, which suffer from problems associated with battery safety. Further, since the battery cell is not particularly limited as long as the battery cell is mounted inside the battery pack case, or the battery cell or pack case is enclosed by the packaging members, the battery pack that can be applied to the present invention may include both pouch-type and square-type battery packs.

The present invention may also be applied to both medium-sized and large-sized battery packs formed by employing a plurality of battery cells as a unit battery, as long as the adhesive members are used in such battery packs.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a small battery pack according to one embodiment of the present invention;

FIG. 2 is a partial assembly view of FIG. 1;

FIG. 3 is an exploded perspective view of FIG. 1; and

FIG. 4 is a schematic cross-sectional view of a flame-retardant double-sided adhesive tape used according to one embodiment of the present invention.

### DETAILED DESCRIPTION OF PREFERRED EMBODIMENTS

Hereafter, preferred embodiments of the present invention will be described in more detail with reference to the accompanying drawings, but are not intended to limit the scope of present invention.

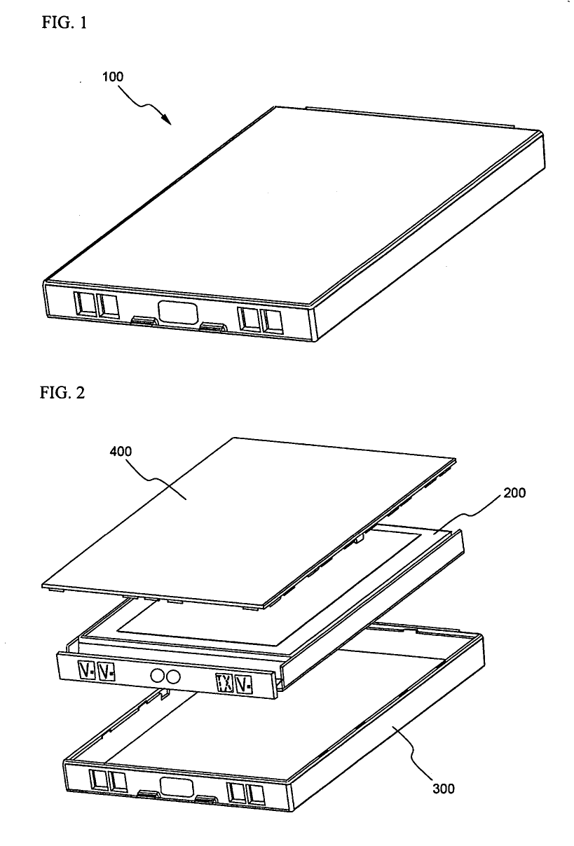

FIGS. 1 through 3 schematically show a perspective view, partial assembly view and exploded perspective view of an illustrative embodiment of the present invention in which a pouch-type battery cell is housed and fixed inside a battery pack case.

Referring to FIGS. 1 and 2, a small battery pack 100 is comprised of a rectangular battery cell 200 in which an electrode assembly composed of a cathode, an anode and a separator, and an electrolyte are contained in a pouch-type battery case 210 in a sealed state; a pack-case body 300 having an inner space that can house the battery cell 200; and a pack case cover 400 for sealing the battery cell 200 via binding with the pack case body 300 having the battery cell 200 housed therein.

In general, such a type of the battery pack 100 is assembled by binding between the pack case body 300 and cover 400, which are respectively made of plastic materials such as polycarbonate (PC), polyacrylonitrile-butadiene-styrene (ABS) and the like, via use of an ultrasonic welding method. The ultrasonic welding method is a method of melt-bonding two joining surfaces using the frictional heat generated by high-frequency mechanical vibrations, for example at 20,000 Hz.

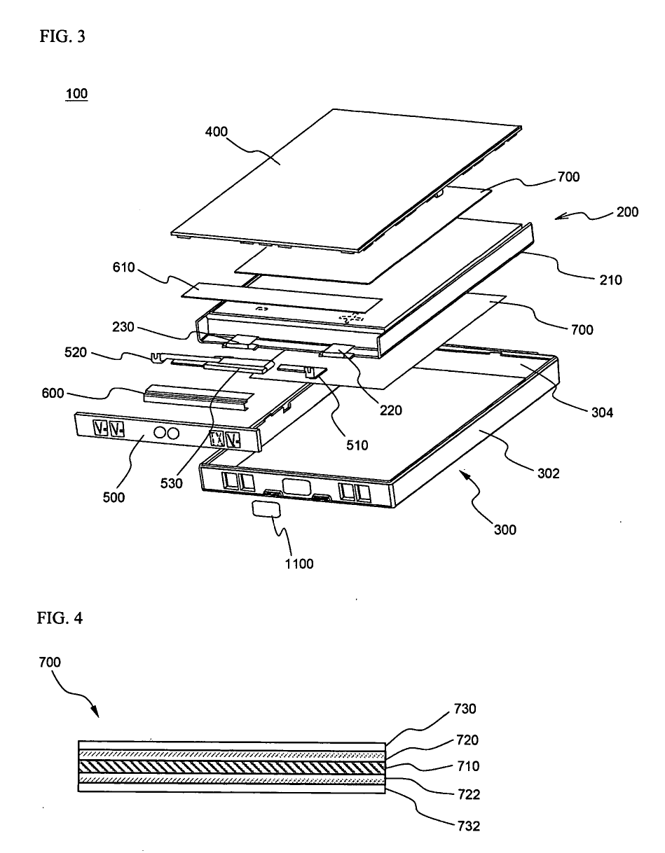

Referring to FIG. 3, a cathode tap 220 and an anode tap 230 are exposed from the battery cell 200. The cathode tap 220 is connected through a cathode lead 510 to a protective circuit module (PCM) 500, whereas the anode tap 230 is connected to the PCM 500 through an anode lead 520 connected to a Positive Temperature Coefficient (PTC) element 530.

The pack case cover 400 is made of a SUS (Steel Use Stainless) material, a kind of stainless steel material according to Japan Industrial Standards. Therefore, when the cover 400 is in contact with PCM 500, electrode leads 220 and 230 and/or PTC 530, electrical short circuiting may occur and therefore insulating members 600 and 610 are installed therebetween. Further, double-sided adhesive tapes 700 are interposed between the pack case body 300 and battery cell 200, and between the pack case cover 400 and battery cell 200, such that the battery cell 200 can be stably fixed under the condition in which it is contained within the pack case body 300 and cover 400.

The present invention is characterized in that such double-sided adhesive tapes 700 and 710 are rendered flame retardant, thereby preventing ignition of the battery pack 100 and inhibiting a further progress thereof upon occurrence of ignition. The double-sided adhesive tapes 700 and 710 serve to integrally fix the battery cell 200 and pack case body 300 and pack case cover 400 and therefore have no direct connection with the operation of the battery. Further, as long as such adhesive tapes exert adhesive force, they do not require superior mechanical strength such as high toughness. As such, it is possible to accomplish desired objects of the present invention.

FIG. 4 illustrates a schematic cross-sectional view of such a double-sided adhesive tape. In the drawing, cross-sectional thicknesses relative to the width of the tape are exaggerated for convenient illustrative purposes only.

Referring now to FIG. 4, as shown in the double-sided adhesive tape 700, adhesive layers 720 and 722, which are, for example, formed of acrylic materials, are applied to both sides of the base film 710 such as a polyester film, and protective release liners 730 and 732 are attached to the respective adhesive layers 720 and 722. As shown in FIG. 3, in order to attach double-sided adhesive tapes 700 to the battery cell 200 and the pack case body 300 and pack case cover 400, the first release liner 730 is first removed and the thus-exposed first adhesive layer 720 is attached to the bottom surface of the battery cell 200 or the top surface of the pack case body 300. Thereafter, the second release liner 732 forming the outer surface of the adhesive tape is removed to expose the second adhesive layer 722 which is then attached to the corresponding surface, i.e., the top surface of the pack case body 300 or the bottom surface of the battery cell 200, to which the double-sided adhesive tape 700 was not attached. In the state where the battery cell 200 was attached to the pack case body 300 as described above, the pack case cover 400 is attached to the top surface of the battery cell 200 to complete binding between the battery cell 200 and the pack case body and cover 300 and 400, similar to the above manner.

As such, the present invention provides a secondary battery having improved safety, by imparting flame retardancy to the base film 710 or adhesive layers 720 and 722, or both thereof. As previously illustrated, imparting of flame retardancy can be realized by addition of flame retardants to the base film 710 and/or adhesive layers 720 and 722, or fabrication of such a base film and/or adhesive layer using flame retardant materials.

### INDUSTRIAL APPLICABILITY

As apparent from the above description, the present invention enables fabrication of a small battery pack having improved flame retardancy without adverse effects on functional elements of the battery and a need for an extra space and further, without modification of a manufacturing process of the battery pack or addition of new processes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A small battery pack having a flame-retardant adhesive member external to a battery cell comprised of an electrode assembly composed of a cathode, an anode, a separator and an electrolyte, and a battery pack case containing the electrode assembly in the sealed state therein.

2. The battery pack according to claim 1, wherein the adhesive member is a double-sided adhesive tape for adhesion between the battery cell and the battery pack case housing the battery cell.

3. The battery pack according to claim 1, wherein the adhesive member is an adhesive for attachment of a packaging member to the outer surface of the battery cell or the battery pack case.

4. The battery pack according to claim 2, wherein the double-sided adhesive tape is composed of a base film and adhesive layers applied to both sides of the base film, and flame retardancy is imparted by adding a flame retardant to the base film or adhesive layer, or the base film and adhesive layer, or fabricating the base film and/or adhesive layer using a flame retardant material.

5. The battery pack according to claim 3, wherein the adhesive is an adhesive layer applied to one side of the packaging member.

6. The battery pack according to claim 4, wherein the flame retardant is added to the adhesive layer, thereby imparting flame retardancy.

7. The battery pack according to claim 4, wherein the base film or packaging member is a polyester film, and the adhesive layer is formed of an acrylic material.

8. The battery pack according to claim 1, wherein the battery cell is a secondary battery.

9. The battery pack according to claim 8, wherein the secondary battery is a lithium secondary battery.

10. The battery pack according to claim 1, wherein the battery cell is a pouch-type battery cell or a square-type battery cell.

11. A medium-sized or large-sized battery pack comprising a plurality of battery cells made of an electrode assembly composed of a cathode, an anode, a separator and an electrolyte, and a battery case containing the electrode assembly in the sealed state therein, wherein flame retardancy is imparted to an adhesive member external to the battery cell.

12. The battery pack according to claim 5, wherein the flame retardant is added to the adhesive layer, thereby imparting flame retardancy.

13. The battery pack according to claim 5, wherein the base film or packaging member is a polyester film, and the adhesive layer is formed of an acrylic material.
